(19) United States
(12) Patent Application Publication
(10) Pub. No.: US 2006/0165840 A1
(43) Pub. Date: Jul. 27, 2006

(54) Fish feed

(75) Inventors: Harald Breivik, Porsgrunn (NO); Berit Annie Aanesen, Skien (NO)

Correspondence Address: FITZPATRICK CELLA HARPER & SCINTO, 30 ROCKEFELLER PLAZA, NEW YORK, NY, 10112, US

(73) Assignee: Norsk Hydro ASA, Oslo (NO)

(21) Appl. No.: 10/520,149

(22) PCT Filed: Jul. 4, 2003
(86) PCT No.: PCT/NO03/00235

§ 371 Date: Jan. 3, 2005

(30) Foreign Application Priority Data
Jul. 5, 2002 (NO) 20023262

(51) Int. Cl. A23K 1/18

(52) U.S. Cl. 426/2

(57) ABSTRACT

This invention relates to a novel feed for farmed fish. The feed comprises tocotrienol. Furthermore, the invention relates to methods for improving the stability and pigment distribution in the fish fillet and processed fish products, as well as stabilization of by-products from farmed fish.

This invention relates to a novel fish feed, use of a particular antioxidant in fish feed, as well as a method for improving the stability of the flesh of all farmed fish species and a method for stabilizing the pigmentation of red fish species. The invention also relates to stabilisation of by-products from farmed fish including fish oil.

Due to the relatively high fat content in some fish species, a degradation of the quality of the fish caused by rancidity takes place after slaughtering. The speed of this degradation determines the lifetime of the fish fillet. Rancidity is an important factor in quality assessment both for fresh and for processed fish. For the distributors of fish and fish fillet it is of great interest to extend the lifetime of the product for all kinds of fish. Furthermore, for reddish fanned fish like salmon and trout, the red pigment in the fish fillet might be partly degraded and unevenly distributed after processing or storage. This is of course not attractive for the customers. For smoked fish fillet this is a particular problem as a yellowish edge often appear on the fillet when smoked.

It is a main object of the present invention to provide fanned fish with improved stability of flesh and pigment. Another object is to improve the stability of processed fish, by-products and fish oil obtained from fanned fish.

This and other objects are achieved in accordance with the attached claims. The general structure of tocopherol is as follows:

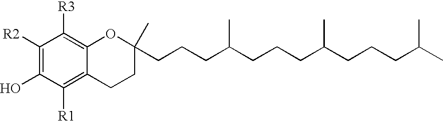

wherein:

| | RI | R2 | R3 |
|---|---|---|---|
| α-tocotrienol | —CH₃ | —CH₃ | —CH₃ |
| β-tocotrienol | —CH₃ | —H | —CH₃ |
| γ-tocotrienol | —H | —CH₃ | —CH₃ |
| δ-tocotrienol | —H | —H | —CH₃ |

As used herein, the term “tocopherol” encompasses any of the α-, β-, γ- and δtocopherol isomers alone, any mixtures of the said isomers, as well as derivatives thereof like esters.

To avoid degradation of tocopherol through production and storage of fish feed, the tocopherol is normally added in ester form, e.g. tocopherol acetate.

The general structure of tocotrienol is as follows:

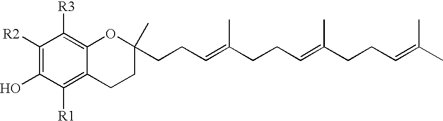

wherein

| | RI | R2 | R3 |
|---|---|---|---|
| α-tocotrienol | —CH₃ | —CH₃ | —CH₃ |
| β-tocotrienol | —CH₃ | —H | —CH₃ |
| γ-tocotrienol | —H | —CH₃ | —CH₃ |
| δ-tocotrienol | —H | —H | —CH₃ |

As used herein, the term “tocotrienol” encompasses any of the α-, β-, γ-and δtocotrienol isomers alone, any mixtures of the said isomers, as well as derivatives thereof like esters.

A person skilled in the art will realize that like the tocopherol above, the tocotrienol should be added in the form of a derivative that not easily is degraded due to oxidation. That is, derivatives like esters are a preferred form of the tocotrienols used in the present invention.

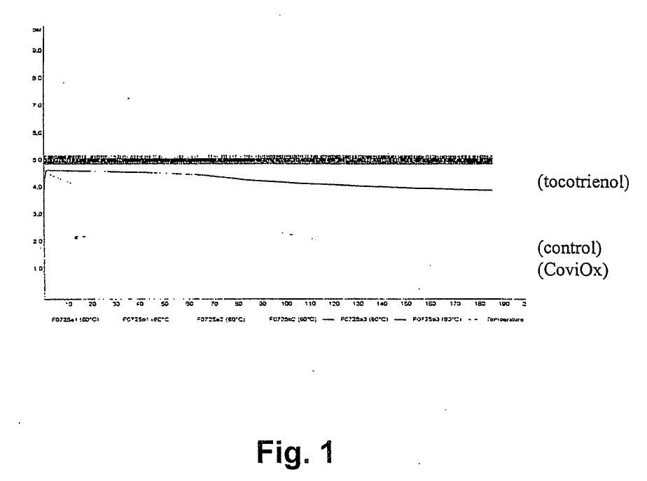

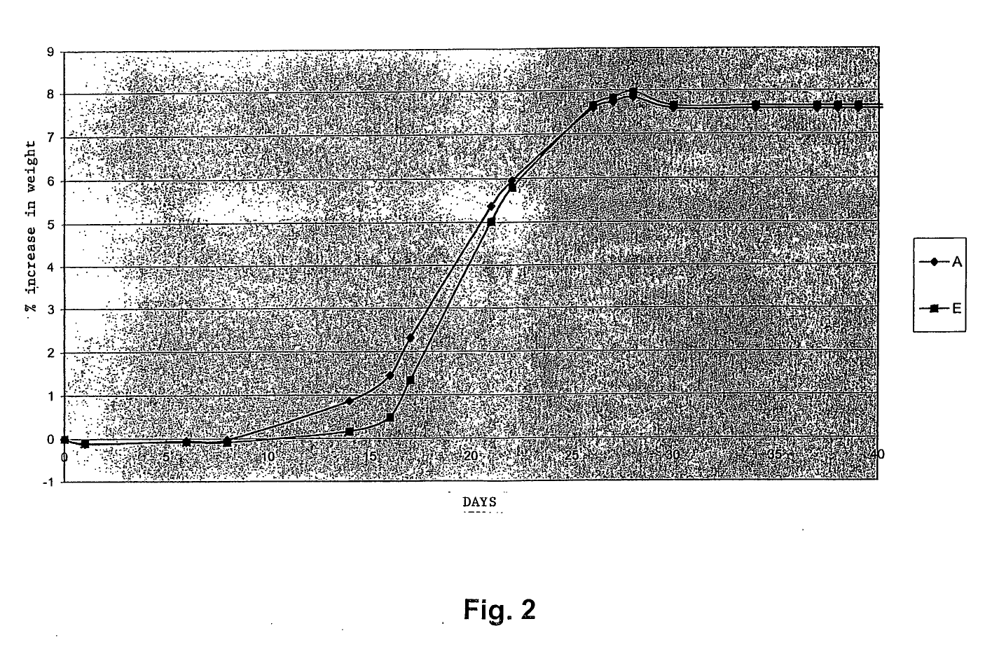

The invention is explained in further detail below with reference to FIGS. 1 and 2.

FIG. 1 shows the effect of fortification of fresh salmon fillet with vitamin E in the form of tocopherols in comparison with fillet fortified with vitamin E in the form of tocotrienols.

FIG. 2 shows the effect of addition of a-tocopherol with regard to stability/shelf life of salmon oil produced by gentle processing of fresh salmon filleting by-products.

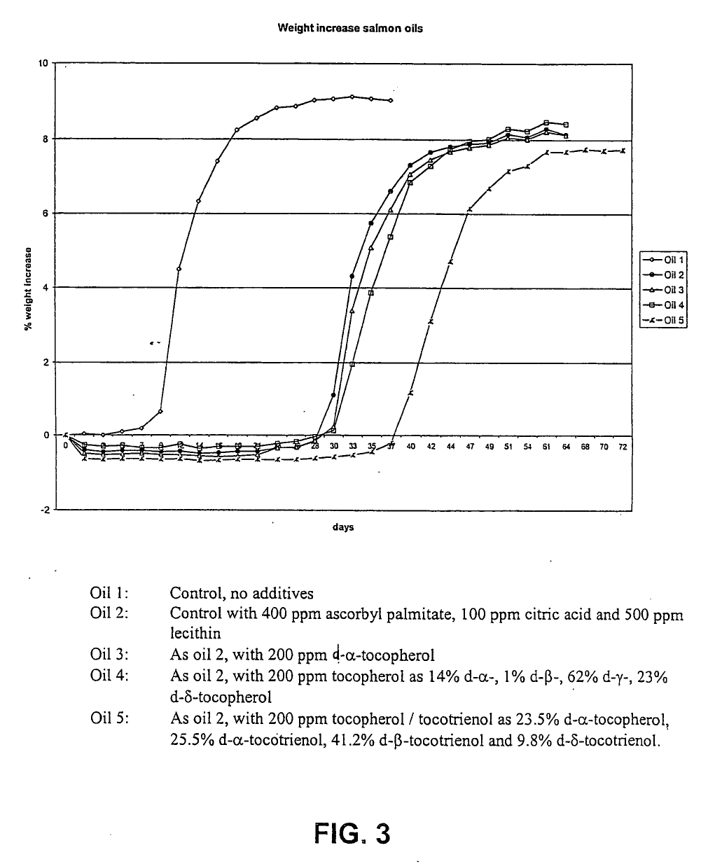

FIG. 3 shows the effect of addition of further a-tocopherol or tocotrienol with regard to stability/shelf file of salmon oil produced by gentle processing of fresh salmon filleting by-products.

It is known that addition of antioxidants to the feed may increase the antioxidant level and consequently the stability of the fish flesh. (Frigg, M., Prabucki, A. L., Ruhdel, E. U.; Aquaculture 84 (1990) 145, Boggio, S. M., Hardy, R. W., Babbitt, J. K., Brannon, E. L.; Aquaculture 51 (1985) 13, Waagbo, R., Sandnes, K., Torrissen, O. J., Sandvin, A., Lie, O; Food Chemistry 46 (1993) 361) Commercial fish feed is added vitamin E in the form of a-tocopherol acetate, in order to be effective within the fish.

It is also known that the optimal levels of vitamin E, in order to have antioxidative effect, are different between different matrixes. This has been confirmed by our 30 experiments.

We have shown that further addition of vitamin E, either as the isolated d-α-isomer or as a mixture of the α-, β-, γ³¹ and δ-isomers, to a fish oil that have been produced from fresh raw materials under inild conditions, or to a fresh fillet, do not result in any increased stability.

When fish oil is prepared from fresh raw materials and under mild conditions, we have found that it already contains close to optimal levels of tocopherol (d-α-tocopherol) when considering the oxidative stability of the oil measured as its induction period. Addition of d-α-tocopherol alone gave weakly prooxidant effects (see FIG. 2). However, further stabilisation was possible by the addition of a combination of ascorbyl palmitate, citric acid and lecithin (see FIG. 3). Including tocopherol in the antioxidant addition did not give further positive results.

However, we have surprisingly found that fortification of the oil or the fillet with vitamin E analogues in the form of tocotrienols, results in increased stability. It is obvious that a preferred way of introducing this antioxidant to the fish flesh and to the fish oil, would be through the feed. Alternatively, the antioxidant might be added to a marinade wherein the fillet is immersed in order to improve the stability of the fillet and the pigmentation distribution in the fillet. In production of processed fish products, the antioxidant may be added to grinded fillet. It also it might be added to the oil that is obtained from by-products of fish.

### Example 1

19.6 ppm Vitamin E, consisting of 14% d-α-tocopherol, 1% d-β-tocopherol, 62% d-γ-tocopherol and 23% d-δ-tocopherol, was grinded together with a fillet sample from farmed salmon 16.3 ppm Vitamin E, consisting of 23.5% d-α-tocopherol, 25.5% d-α-tocotrienol, 41.2% d-γ-tocotrienol and 9.8% d-δ-tocotrienol, was grinded together with another fillet sample from farmed salmon (shown as tocotrienol in FIG. 1).

As a control, grinded fresh farmed salmon fillet without further addition of antioxidants was used

The relative stability of these samples towards oxidation was measured in an accelerated test, using the Oxipres apparatus. The samples were weighed into separate cells, where they were subjected to 60° C. and 4 bar air pressure. The oxygen consumption caused by the reaction of the sample with oxygen in the air, was recorded as a pressure drop.

These experiments surprisingly showed that addition of tocotrienol resulted in a significantly additive protecting effect, shown by that the pressure drop in these cells were slower than in the cells with control or tocopherol (CoviOx) fortified samples. The addition of tocopherol did not stabilise the samples relative to the control.

### Example 2

Fish oil prepared from fresh salmon raw materials contains close to optimal levels of tocopherol. As illustrated in FIG. 2, further addition of d-α-tocopherol to this oil did not increase stability, but gave instead a small prooxidant effect. The oil stability was measured as the induction period (in days) in weight increase experiment. Oil A is salmon oil with 200 ppm d-α-tocopherol. Oil E is the control without additions.

To a sample of fresh fish oil prepared by gentle processing of fresh salmon filleting by-products (viscera, heads, framebones), we added 200 ppm vitamin E consisting of 89-99% d-α-tocopherol and 1-11% (β+γ+δ)-tocopherols (according to product specification), and a mixture of other/synergistic.

To another sample of the oil, we added 200 ppm vitamin E consisting of 14% d-α-tocopherol, 1% d-β-tocopherol, 62% d-γ-tocopherol and 23% d-δ-tocopherol, and a mixture of other/synergistic antioxidants similar to what was given to the first sample.

To a third sample of the oil, we added 200 ppm vitamin E consisting of 23.5% d-α-tocopherol, 25.5% d-α-tocotrienol, 41.2% d-γ-tocotrienol and 9.8% d-δ-tocotrienol, and a mixture of other/synergistic antioxidants similar to what was given to the other samples.

The oxidative stability of the three oils were tested by subjecting 3.0 g samples in 6.0 cm glass petri dishes to a temperature of 35° C. while exposed to air. The oxygen uptake caused by oxidation was recorded as a rapid weight increase of the samples when their antioxidative resistance was broken down, after an initial induction time (IP). The respective induction times of the samples are shown in FIG. 3.

1. A fish feed, comprising 25-70% by weight of proteins, 5-60% by weight of lipids and 0-40% by weight of carbohydrates, and pigment in combination with 0-15% by weight of one or more additional components; such as fillers, adhesives, preservatives, vitamins and minerals, wherein tocotrienol also is present.

2. A fish feed according to claim 1, wherein tocotrienol is present in an amount of 30 to 800 mg/kg.

3. A fish feed according to claim 1 or 2, wherein tocotrienol is present in an amount of 80 to 300 mg/kg.

4. Use of tocotrienol in fish feed to improve stability of fish fillet and pigmentation distribution in fish fillet.

5. Method for improving the stability of fish fillet and pigment distribution in the fish fillet by adding tocotrienol to the feed.

6. Method for improving the stability of processed fish products by adding tocotrienol to grinded fish fillet.

7. By-products from farmed fish including fish oil, wherein the fish is fed a feed according to claim 1.

8. Fish oil from farmed fish, wherein tocotrienol is added directly to the oil.

9. A process for pre-treating fish fillet, comprising immersing the fillet in a tocotrienol-containing marinade before treatment.

10. A process for pre-treating fish fillet according to claim 8, wherein the treatment is smoking.
